(19) United States
(12) Patent Application Publication
(10) Pub. No.: US 2006/0220997 A1
(43) Pub. Date: Oct. 5, 2006

(54) Plasma display apparatus and method of driving plasma display

(75) Inventors: Byeong Kil Ahn, Seoul (KR); Seung Chan Baek, Seoul (KR); Namjin Kim, Seoul (KR); Seonghak Moon, Seoul (KR); Joo Young Lee, Seoul (KR); Daihyun Kim, Gunpo-si (KR)

Correspondence Address: FLESHNER & KIM, LLP, P.O. BOX 221200, CHANTILLY, VA, 20153, US

(73) Assignee: LG Electronics Inc.

(21) Appl. No.: 11/391,296

(22) Filed: Mar. 29, 2006

(30) Foreign Application Priority Data
Mar. 30, 2005 (KR) 10-2005-0026754
Apr. 8, 2005 (KR) 10-2005-0029690

(51) Int. Cl. G09G 3/28

(52) U.S. Cl. 345/63

(57) ABSTRACT

A plasma display apparatus and a method of driving the plasma display apparatus are provided. The plasma display apparatus sets a part of the entire image signal corresponding to a specific region of a plasma display panel to a gray level value 0.

This Nonprovisional application claims priority under 35 U.S.C. § 119(a) on Patent Application Nos. 10-2005-0026754 and 10-2005-0029690 filed in Korea on Mar. 30, 2005 and Apr. 8, 2005 the entire contents of which are hereby incorporated by reference.

### BACKGROUND OF THE INVENTION

1. Field of the Invention

This document relates to a plasma display apparatus and a method of driving the plasma display apparatus.

2. Description of the Background Art

A plasma display apparatus displays an image on a plasma display panel. Each of cells of the plasma display panel is filled with an inert gas containing a main discharge gas such as neon (Ne), helium (He) or a Ne—He gas mixture and a small amount of xenon (Xe). When a high frequency voltage is supplied to an electrode of the plasma display panel, the inert gas within the cells emits vacuum ultraviolet rays. The image is displayed by the light-emission of a phosphor formed between barrier ribs.

An inverse gamma correction process or a half-toning process, and the like, is performed on an image signal, and then the image signal is change into image data capable of being displayed on the plasma display panel.

When the image is displayed on the plasma display panel through the plasma display apparatus, a black region is generated in the plasma display panel by a difference in a ratio of a screen occupied by the image. For example, a ratio of a screen occupied by an image displayed by an image signal transmitted from a broadcasting station is 1.33:1 and a ratio of a screen occupied by an image in a case of a film is 1.85:1 or 2.35:1. Thus, when the film is displayed through the plasma display apparatus, a black region is generated in the plasma display panel.

### SUMMARY OF THE INVENTION

Accordingly, an object of the present invention is to solve at least the problems and disadvantages of the background art

According to an aspect, a plasma display apparatus comprises a plasma display panel comprising an electrode, a region setting unit for setting a part of entire image signal corresponding to a specific region of the plasma display panel to a gray level value 0, and for outputting image data corresponding to the gray level value 0 for the duration of time equal to or more than predetermined frames, and an electrode driver for supplying a driving signal corresponding to the image data to the electrode.

According to another aspect, a plasma display apparatus comprises a plasma display panel comprising a plurality of electrodes, a region setting unit for setting a part of entire image signal corresponding to a specific region of the plasma display panel to a gray level value 0, and for outputting image data corresponding to the gray level value 0, and an electode driver for cutting off a driving signal supplied to one or more electrodes of the plurality of electrodes located in the specific region.

According to still another aspect, a method of driving a plasma display apparatus comprising a plasma display panel comprising a plurality of electrodes comprises setting a part of entire image signal correponding to a specific region of the plasma display panel to a gray level value 0, outputting image data corresponding to the gray level value 0 for the duration of time equal to or more than predetermined frames, and supplying a driving signal corresponding to the image data to one or more electrodes of the plurality of electrodes located inside the specific region.

According to yet still another aspect, in a method of driving a plasma display apparatus comprising a plasma display panel comprising a plurality of electrodes, on the occasion of outputting an image signal, whose a gray level value equals to 0, corresponding to at least a portion region of a specific region of the plasma display panel for the duration of time equal to or more than predetermined frames, a driving signal for driving a cell located in at least the portion region of the specific region is cut off.

### BRIEF DESCRIPTION OF THE DRAWINGS

The embodiment of the invention will be described in detail with reference to the following drawings in which like numerals refer to like elements.

FIG. 1 is a block diagram of a plasma display apparatus according to an embodiment of the present invention;

FIG. 2 is a block diagram of a region setting unit of the plasma display apparatus according to the embodiment of the present invention;

FIG. 3 illustrates an example of an image displayed on the plasma display apparatus according to the embodiment of the present invention; and

FIG. 4 is a circuit diagram of a scan electrode driver of the plasma display apparatus according to the embodiment of the present invention.

### DETAILED DESCRIPTION OF PREFERRED EMBODIMENTS

Embodiments of the present invention will be described in a more detailed manner with reference to the drawings.

A plasma display apparatus according to an embodiment of the present invention comprises a plasma display panel comprising an electrode, a region setting unit for setting a part of entire image signal corresponding to a specific region of the plasma display panel to a gray level value 0, and for outputting image data corresponding to the gray level value 0 for the duration of time equal to or more than predetermined frames, and an electrode driver for supplying a driving signal corresponding to the image data to the electrode.

The total region of the plasma display panel may be divided into a upper part, a first middle part and a lower part, or may be divided into a left side part, a second middle part and a right side part. The specific region may comprise at least one of the upper part, the lower part, the left side part, or the right side part.

The region setting unit may comprise a signal detecting unit for detecting the part of entire image signal, an object judging unit for judging whether an object displayed on the detected specific region, exists or not according to the part of entire image signal, and a region set performing unit for setting a gray level value of an image signal corresponding to the remaining specific region except a portion of the specific region occupied by the object to the gray level value 0, and for outputting the image data.

The number of the predetermined flames may equal to 5.

The electrode may comprise an address electrode, and the electrode driver may supply a driving signal of a ground level to the address electrode depending on the image data corresponding to the gray level value 0.

An average gray level value of the part of entire image signal may be equal to or less than a first threshold.

The object judging unit may judge that the object displayed on the specific region, exists when the number of cell groups of a gray level value more than a second threshold value among the plurality of cell groups comprised in an M×N block of the specific region, is greater than a reference value. M equals to the number of horizontal cell groups, and N equals to the number of vertical cell groups.

The cell group may comprise a pixel.

The first threshold value may equal to 1.

The second threshold value may equal to 1.

The reference value may be equal to or more than 3.

A plasma display apparatus according to the embodiment of the present invention comprises a plasma display panel comprising a plurality of electrodes, a region setting unit for setting a part of entire image signal corresponding to a specific region of the plasma display panel to a gray level value 0, and for outputting image data corresponding to the gray level value 0, and an electrode driver for cutting off a driving signal supplied to one or more electrodes of the plurality of electrodes located in the specific region.

One or more electrodes may not intersect a region on which the object is displayed.

The electrode drivers may comprise a first driving signal supply unit for cutting off the driving signal supplied to the one or more electrodes of the plurality of electrodes located in the specific region, and a second driving signal supply unit for outputting the driving signal corresponding to the image data to the remaining electrodes.

The first driving signal supply unit may comprise a blocking switch for cutting off a sustain pulse supplied to the one or more electrodes during a sustain period.

A method of driving a plasma display apparatus comprising a plasma display panel comprising a plurality of electrodes, according to the embodiment of the present invention comprises setting a part of entire image signal corresponding to a specific region of the plasma display panel to a gray level value 0, outputting image data corresponding to the gray level value 0 for the duration of time equal to or more than predetermined frames, and supplying a driving signal corresponding to the image data to one or more electrodes of the plurality of electrodes located inside the specific region.

The setting of the gray level value to 0 may comprise detecting the part of entire image signal, judging whether an object displayed on the detected specific region, exists or not according to the entire image signal, and setting a gray level value of an image signal corresponding to the remaining specific region except a portion of the specific region occupied by the object to the gray level value 0.

A driving signal supplied to an electrode of the plurality of electrodes, which does not intersect a region corresponding to the object, may be cut off.

The specific region may be equal to or less than half of the entire region of the plasma display panel on which an image is displayed.

In a method of driving a plasma display apparatus comprising a plasma display panel comprising a plurality of electrodes, according to the embodiment of the present invention, on the occasion of outputting an image signal, whose a gray level value equals to 0, corresponding to at least a portion region of a specific region of the plasma display panel for the duration of time equal to or more than predetermined frames, a driving signal for driving a cell located in at least the portion region of the specific region is cut off

The driving signal may be a reset signal or a sustain signal.

The specific region may be equal to or less than half of the whole region of the plasma display panel on which an image is displayed.

Hereinafter, exemplary embodiments of the present invention will be described in detail with reference to the attached drawings.

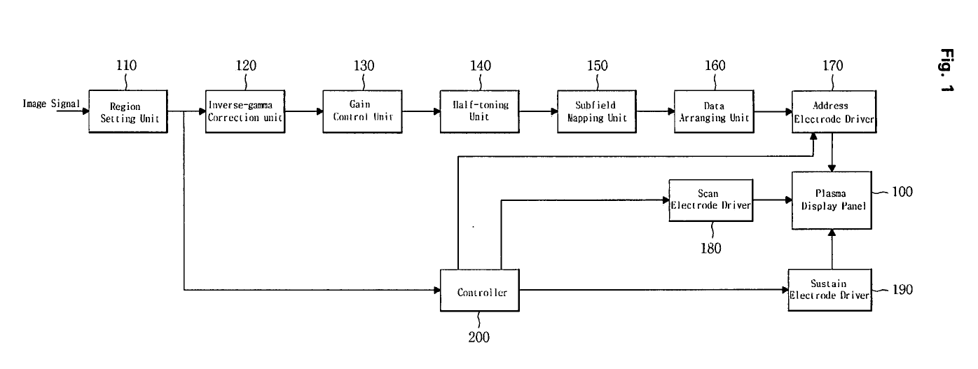

FIG. 1 is a block diagram of a plasma display apparatus according to an embodiment of the present invention. As shown in FIG. 1, the plasma display apparatus according to the embodiment of the present invention comprises a plasma display panel 100, a region setting unit 110, an inversion gamma correction unit 120, a gain control unit 130, a half toning unit 140, a subfield mapping unit 150, a data arranging unit 160, an address electrode driver 170, a scan electrode driver 180, a sustain electrode driver 190 and a controller 200.

The plasma display panel 100 comprises an address electrode, a scan electrode and a sustain electrode. The address electrode receives a driving signal corresponding to image data. The scan electrode receives a reset signal for uniformalizing wall charges within cells, a scan signal for selecting a cell to be discharged and a sustain signal for maintaining a discharge of the selected cell. The sustain electrode receives a sustain signal for maintaining a discharge of the selected cell.

The region setting unit 110 sets a part of the entire image signal to a gray level value 0, and outputs image data corresponding to the gray level value 0 for the duration of time equal to or more than predetermined frames. The part of the entire image signal corresponds to a specific region of the plasma display panel 100. In other words, the region setting unit 110 sets an image signal corresponding to a black region generated by a difference in a screen ratio to a gray level value 0 and outputs image data corresponding to the gray level value 0 for the duration of time equal to or more than a predetermined frames. The region setting unit 110 may output the image data corresponding to the gray level value 0 for the duration of time equal to or more than five frames. Since a brightness value of the specific region is minimum, the concentration of a viewer on a general region where an image is displayed is higher and contrast of the plasma display apparatus increases.

The inversion gamma correction unit 120 performs inversion-gamma correction on the image data input from the region setting unit 110 and an image signal corresponding to the general region.

The gain control unit 130 controls gains of the image data and the image signal corrected by the inversion-gamma correction unit 120.

The half toning unit 140 diffuses a quantization error of the image data and the image signal input from the gain control unit 130 and performs a dithering process.

The subfield mapping unit 150 performs a subfield-mapping process on the image data and the image signal input from the half toning unit 140.

The data arranging unit 160 rearranges subfield data obtained by performing the subfield mapping process on the image data or the image signal by each of subfields, and then outputs address data.

Since the image data output from the region setting unit 110 corresponds to the gray level value 0, a noise generated by performing operations of the inversion gamma correction unit 120, the gain control unit 130, the half toning unit 140, the subfield mapping unit 150 and the data arranging unit 160 can be prevented. In particular, a half toning pattern generated by performing a half toning process of the half toning unit 140 on the image data can be prevented.

Since the plasma display apparatus according to the embodiment of the present invention sets the gray scale value of the image signal corresponding to the specific region to 0, an APL (average picture level) decreases and the contrast increases by increasing a weight value of the number of sustain signals.

Under the control of the controller 200, the address electrode driver 170 supplies a driving signal in accordance to address data output from the data arranging unit 160 to the address electrode of the plasma display panel 100. In other words, the address electrode driver 170 supplies a driving signal corresponding to the image data output from the region setting unit 110 to the address electrode. Since the plasma display apparatus according to the embodiment of the present invention sets the gray scale value of the image signal corresponding to the specific region to 0, the number of switching operations of the address electrode driver 170 decreases.

Under the control of the controller 200, the scan electrode driver 180 supplies the reset signal, the scan signal or the sustain signal to the scan electrode of the plasma display panel 100.

Under the control of the controller 200, the sustain electrode driver 190 supplies the sustain signal to the sustain electrode of the plasma display panel 100.

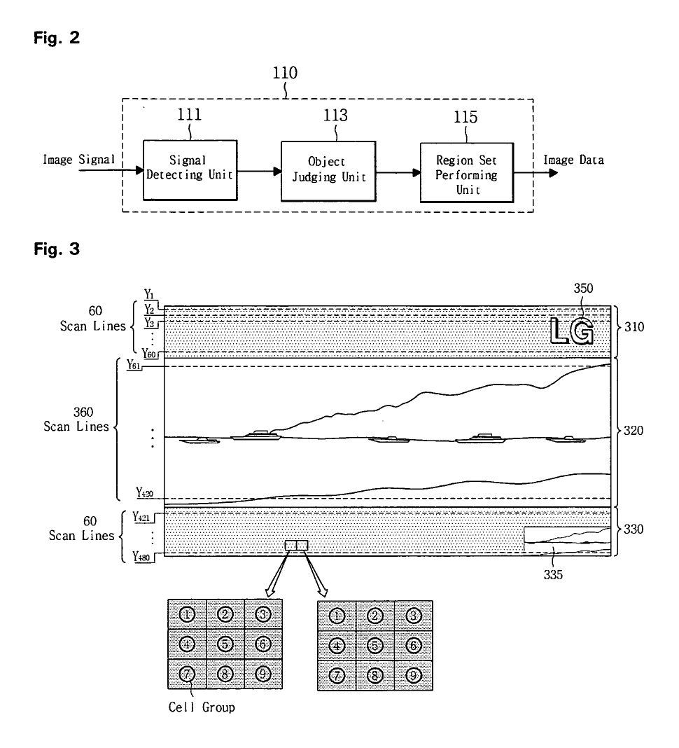

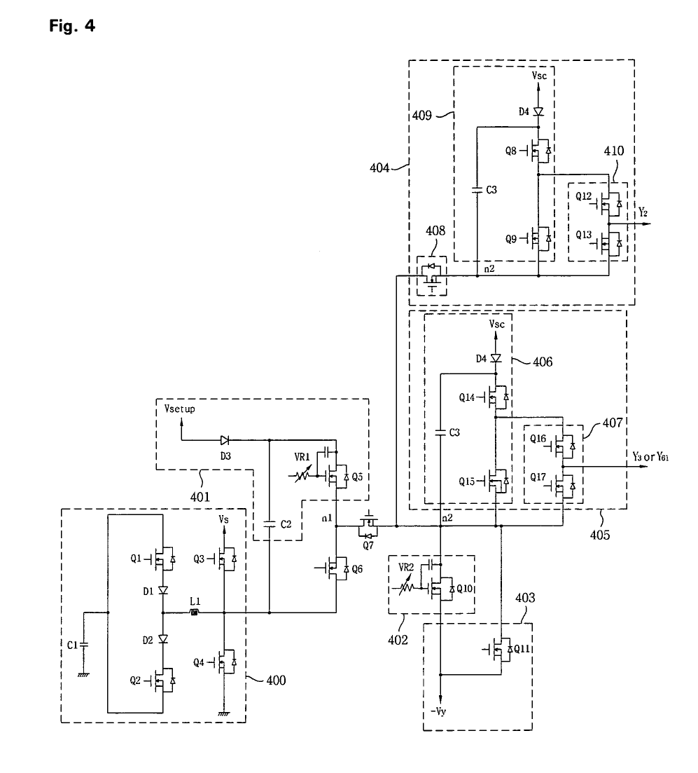

Next, the region setting unit 110 of the plasma display apparatus according to the embodiment of the present invention is described in detail with reference to FIGS. 2 and 3.

FIG. 2 is a block diagram of a region setting unit of the plasma display apparatus according to the embodiment of the present invention. FIG. 3 illustrates an example of an image displayed on the plasma display apparatus according to the embodiment of the present invention. As shown in FIG. 2, the region setting unit 110 of the plasma display apparatus according to the embodiment of the present invention comprises a signal detecting unit 111, an object judging unit 113 and a region set performing unit 115.

The signal detecting unit 111 detects the part of the entire image signal whose an average gray level value is equal to or less than a first threshold value. That is, when specific regions 310 and 330 of the plasma display panel of FIG. 3 is displayed in black by a reason such as the difference in the screen ratio, the signal detecting unit 111 detects the part of the entire image signal, whose the average gray level value is equal to or less than the first threshold value, so as to detect an image signal corresponding to the specific regions 310 and 330. In the embodiment of the present invention, the first threshold value equals to 1.

The object judging unit 113 judges whether objects 315 and 335 displayed on the specific regions 310 and 330 exist or not according to the entire image signal. In the embodiment of the present invention, the object 315 such as a logo is displayed on the upper specific regions 310 and the object 335 such as a sub-screen is displayed on the lower specific regions 330. When a plurality of cell groups included in the specific region 310 and 330 are divided into a plurality of M×N blocks, the object judging unit 113 judges that the objects 315 and 335 exist, when the number of cell groups of a gray level value more than a second threshold value among the plurality of cell groups included in each of the plurality of M×N blocks is greater than a reference value.

M equals to the number of horizontal cell groups, and N equals to the number of vertical cell groups. In the embodiment of the present invention, 3×3 block is used. Further, the cell group includes one or more cells. In the embodiment of the present invention, the cell group is referred to as a pixel including a cell in which a red phosphor is formed, a cell in which a green phosphor is formed, and a cell in which a blue phosphor is formed.

For example, as shown in FIG. 3, an image signal of a screen ratio of 1.85:1 (=16:9) is displayed on a screen of a screen ratio of 1.33:1 (=4:3). In a case of the screen supporting 480 scan lines, the black region 310 of 60 scan lines located in an upper part of the screen and the black region 330 of 60 scan lines located in a lower part of the screen are displayed.

When the second threshold value equals to 1 and the reference value equals to 3, the object judging unit 113 compares a gray level value of each of 9 cell groups included in the 3×3 block of FIG. 3 with the second threshold value (=1). The object judging unit 113 counts the number of cell groups of a gray level value greater than the second threshold value (=1) from the comparison result. The object judging unit 113 judges a cell group (\hat{5}) in the center of the 3×3 block as the object, when the counted number of cell groups is greater than the reference value (=3). The object judging unit 113 may judge the 3×3 block as the object depending on the setting of a user. After the object judging unit 113 completes to judge one 3×3 block of the plurality of 3×3 blocks, the object judging unit 113 judges the next 3×3 block in the same manner as one 3×3 block.

Since the object judging unit 113 of the plasma display apparatus according to the embodiment of the present invention judges whether the object exists or not by a block unit for preventing a pixel of a high gray level value from being judged as the object by a noise, the responsibility of the object judgment is secured.

The region set performing unit 630 sets a gray level value of an image signal corresponding to the remaining specific region except a portion of the specific region occupied by the object to a gray level value 0, and outputs image data corresponding to the gray level value 0.

In the embodiment of the present invention, the specific regions 310 and 330 may be equal to or less than half of the entire region of the plasma display panel on which an image is displayed.

As shown in FIG. 3, the object does not always exist in an image displayed on the plasma display apparatus according to the embodiment of the present invention. Further, the specific region includes at least one of an upper part and a lower part of the plasma display panel, on which the image is displayed, in FIG. 3. However, the specific region may include at least one of a left side part and a right side part of the plasma display panel, on which the image is displayed.

As shown in FIG. 1, the scan driver 180 of the plasma display apparatus according to the embodiment of the present invention can block the reset signal or the sustain signal supplied to one or more scan electrodes located in the specific region. Since the plasma display apparatus according to the embodiment of the present invention blocks the reset signal or the sustain signal, the contrast is improved and power consumption decreases.

FIG. 4 is a circuit diagram of a scan electrode driver of the plasma display apparatus according to the embodiment of the present invention. As shown in FIG. 4, the scan electrode driver 180 driver of the plasma display apparatus according to the embodiment of the present invention comprises a sustain voltage supply unit 400, a setup voltage supply unit 401, a sustain voltage control switch Q6, a setup voltage control switch Q7, a set-down voltage supply unit 402, a scan voltage supply unit 403, a first driving signal supply unit 404 and a second driving signal supply unit 405.

The sustain voltage supply unit 400 supplies a sustain voltage Vs to a plurality of scan electrodes Y₂, Y₃ and Y₆₁ of FIG. 3 through a third switch Q3. The sustain voltage supply unit 400 supplies or recovers an ineffective energy to or from the plurality of scan electrodes Y₂, Y₃ and Y₆₁ through operations of first and second switches Q1 and Q2. The scan electrodes Y₂ and Y₃ of the plurality of scan electrodes Y₂, Y₃ and Y₆₁ are located in the specific region 310 of FIG. 3 and the scan electrode Y₆₁ is located in the general region 320 where the image is displayed.

The setup voltage supply unit 401 receives a sum of the sustain voltage Vs supplied form the sustain voltage supply unit 400 and a voltage value of a setup voltage source Vsetup. Then, the setup voltage supply unit 401 applies a rising ramp signal, which rises from the sustain voltage Vs, to the scan electrodes Y₂, Y₃ and Y₆₁ by an operation of a fifth switch Q5.

After the supply of the rising ramp signal by the setup voltage supply unit 401, the set-down voltage supply unit 402 applies a falling ramp signal, which falls from the sustain voltage Vs, to the scan electrodes Y₂, Y₃ and Y₆₁ by an operation of a tenth switch Q10.

The rising ramp signal generated by the setup voltage supply unit 401 and the falling ramp signal generated by the set-down voltage supply unit 402 forms a reset signal.

The scan voltage supply unit 403 sequentially supplies a writing scan voltage -Vy for selecting cells to be turned on to the scan electrodes Y₂, Y₃ and Y₆₁ by an operation of an eleventh switch Q11.

The sustain voltage control switch Q6 is located on a path for supplying or recovering the sustain voltage Vs to or from the scan electrodes Y₂, Y₃ and Y₆₁ by the sustain voltage supply unit 400.

The setup voltage control switch Q7 comprises an internal diode of an opposite direction of a direction of a diode of the sustain voltage control switch Q6. The setup voltage control switch Q7 prevents a voltage applied to a second node n2 from being a ground level voltage.

Under the control of the controller 200 of FIG. 1, the first driving signal supply unit 404 cut offs a driving signal supplied to the scan electrode Y₂ of the plurality of scan electrodes Y₂, Y₃ and Y₆₁ of FIG. 3, which is located in the specific region 310 and does not intersect the object 315.

The first driving signal supply unit 404 comprises a first drive integrated circuit (° C.) 410, a first scan reference voltage supply unit 409 and a blocking switch 408. The first drive IC 410 applies a driving signal to the scan electrodes Y₂. The first scan reference voltage supply unit 409 supplies a scan reference voltage Vsc through the first drive IC 410 during an address period. The blocking switch 408 is located on a path for the supply of the reset signal, the scan signal and the sustain signal and is commonly connected to the first drive IC 410 and the first scan reference voltage supply unit

The controller 200 of FIG. 1 receives the image data corresponding to the gray level value 0 from the region setting unit 110. Then, the controller 200 of FIG. 1 turns off the blocking switch 408 of the first driving signal supply unit 404 of FIG. 4 connected to the scan electrode Y₂, which does not intersect the object 315 of FIG. 3. When turning off the blocking switch 408, at least one of the reset signal, the scan signal or the sustain signal supplied to the scan electrode Y₂, which does not intersect the object 315, is cut off.

In other words, the first driving signal supply unit 404 cuts off the driving signal supplied to the scan electrode, which does not intersect the object 315. Thus, a discharge is not generated in cells located on the scan electrode, which does not intersect the object 315. When the object 315 doses not exist in the specific region, the first driving signal supply unit 404 connected to all of the scan electrodes located in the specific region may comprise the blocking switch.

The second driving signal supply unit 405 comprises a second drive IC 407 for applying a driving signal to the scan electrode Y₃ or Y₆₁, and a second scan reference voltage supply unit 409 for supplying a scan reference voltage Vsc through the second drive IC 407 during the address period. The second driving signal supply unit 405 supplies the reset signal, the scan signal and the sustain signal to the scan electrode Y₃, which is located in the specific region 310 of FIG. 3 and intersects the object 315, or the scan electrode Y₆₁ located in the general region 320. In other words, the second driving signal supply unit 405 supplies the driving signal to the scan electrode intersecting the object and the scan electrode located in the general region 320.

As described above, the contrast improves and the power consumption decreases by cutting off the driving signal supplied to the scan electrode which is located in the specific region and does not intersect the object.

The embodiment of the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display apparatus comprising:
a plasma display panel comprising an electrode;
a region setting unit for setting a part of entire image signal corresponding to a specific region of the plasma display panel to a gray level value 0, and for outputting image data corresponding to the gray level value 0 for the duration of time equal to or more than predetermined frames; and
an electrode driver for supplying a driving signal corresponding to the image data to the electrode.

2. The plasma display apparatus of claim 1, wherein the total region of the plasma display panel is divided into a upper part, a first middle part and a lower part, or is divided into a left side part, a second middle part and a right side part,
wherein the specific region comprises at least one of the upper part, the lower part, the left side part, or the right side part.

3. The plasma display apparatus of claim 1, wherein the region setting unit comprises a signal detecting unit for detecting the part of entire image signal; an object judging unit for judging whether an object displayed on the detected specific region, exists or not according to the part of entire image signal; and a region set performing unit for setting a gray level value of an image signal corresponding to the remaining specific region except a portion of the specific region occupied by the object to the gray level value 0, and for outputting the image data.

4. The plasma display apparatus of claim 1, wherein the number of the predetermined frames equals to 5.

5. The plasma display apparatus of claim 1, wherein the electrode comprises an address electrode, and the electrode driver supplies a driving signal of a ground level to the address electrode depending on the image data corresponding to the gray level value 0.

6. The plasma display apparatus of claim 3, wherein an average gray level value of the part of entire image signal is equal to or less than a first threshold.

7. The plasma display apparatus of claim 3, wherein the object judging unit judges that the object displayed on the specific region, exists when the number of cell groups of a gray level value more than a second threshold value among the plurality of cell groups comprised in an M×N block of the specific region, is greater than a reference value,
wherein M equals to the number of horizontal cell groups, and N equals to the number of vertical cell groups.

8. The plasma display apparatus of claim 7, wherein the cell group comprises a pixel.

9. The plasma display apparatus of claim 6, wherein the first threshold value equals to 1.

10. The plasma display apparatus of claim 7, wherein the second threshold value equals to 1.

11. The plasma display apparatus of claim 7, wherein the reference value is equal to or more than 3.

12. A plasma display apparatus comprising:
a plasma display panel comprising a plurality of electrodes;
a region setting unit for setting a part of entire image signal corresponding to a specific region of the plasma display panel to a gray level value 0, and for outputting image data corresponding to the gray level value 0; and
an electrode driver for cutting off a driving signal supplied to one or more electrodes of the plurality of electrodes located in the specific region.

13. The plasma display apparatus of claim 12, wherein one or more electrodes do not intersect a region on which the object is displayed.

14. The plasma display apparatus of claim 12, wherein the electrode drivers comprises a first driving signal supply unit for cutting off the driving signal supplied to the one or more electrodes of the plurality of electrodes located in the specific region; and a second driving signal supply unit for outputting the driving signal corresponding to the image data to the remaining electrodes.

15. The plasma display apparatus of claim 14, wherein the first driving signal supply unit comprises a blocking switch for cutting off a sustain pulse supplied to the one or more electrodes during a sustain period.

16. A method of driving a plasma display apparatus comprising a plasma display panel comprising a plurality of electrodes, comprising,
setting a part of entire image signal corresponding to a specific region of the plasma display panel to a gray level value 0;
outputting image data corresponding to the gray level value 0 for the duration of time equal to or more than predetermined frames; and
supplying a driving signal corresponding to the image data to one or more electrodes of the plurality of electrodes located inside the specific region.

17. The method of claim 16, wherein the setting of the gray level value to 0 comprises detecting the part of entire image signal; judging whether an object displayed on the detected specific region, exists or not according to the entire image signal; and setting a gray level value of an image signal corresponding to the remaining specific region except a portion of the specific region occupied by the object to the gray level value 0.

18. The method of claim 17, wherein an average gray level value of the part of entire image signal is equal to or less than a first threshold.

19. The method of claim 17, wherein the object displayed on the specific region exists, when the number of cell groups of a gray level value greater than a second threshold value among the plurality of cell groups comprised in an M×N block of the specific region is greater than a reference value,
wherein M equals to the number of horizontal cell groups, and N equals to the number of vertical cell groups.

20. The method of claim 19, wherein the cell group comprises a pixel.

21. The method of claim 16, wherein the number of predetermined frames is equal to or more than 5.

22. The method of claim 17, wherein a driving signal supplied to an electrode of the plurality of electrodes, which does not intersect a region corresponding to the object, is cut off.

23. The method of claim 16, wherein the specific region is equal to or less than half of the entire region of the plasma display panel on which an image is displayed.

24. A method of driving a plasma display apparatus comprising a plasma display panel comprising a plurality of electrodes,
wherein on the occasion of outputting an image signal, whose a gray level value equals to 0, corresponding to at least a portion region of a specific region of the plasma display panel for the duration of time equal to or more than predetermined frames, a driving signal for driving a cell located in at least the portion region of the specific region is cut off.

25. The method of claim 24, wherein the driving signal is a reset signal or a sustain signal.

26. The method of claim 24, wherein the specific region is equal to or less than half of the whole region of the plasma display panel on which an image is displayed.

27. The method of claim 24, wherein the number of the predetermined frames equals to 5.
